(19) United States
(12) Patent Application Publication
(10) Pub. No.: US 2024/0002703 A1
(43) Pub. Date: Jan. 4, 2024

(54) WAVELENGTH SELECTIVE ADHESIVE COMPOSITIONS

(71) Applicant: 3M INNOVATIVE PROPERTIES COMPANY, St. Paul, MN (US)

(72) Inventors: Encai Hao, Woodbury, MN (US); John Wheatley, Stillwater, MN (US); Nicholas Untiedt, Minneapolis, MN (US)

(21) Appl. No.: 18/213,954

(22) Filed: Jun. 26, 2023

Related U.S. Application Data
(60) Provisional application No. 63/357,236, filed on Jun. 30, 2022.

(51) Int. Cl. C09J 11/06; C09J 7/38; C09J 7/10; C09B 57/00; C09B 67/20; G02B 5/28

(52) U.S. Cl. CPC C09J 11/06; C09J 7/385; C09J 7/10; C09B 57/007; C09B 67/0063; G02B 5/281; C09J 2203/326; C09J 2301/302; C09J 2301/408; C09J 2301/414; C09J 2433/00

(57) ABSTRACT

Adhesive compositions include a pressure sensitive adhesive, and at least 2 light absorbing components dispersed within the pressure sensitive adhesive. The light absorbing components are dyes, nanopigments or a combination thereof. The light absorbing components absorb light in the wavelength range of 350-700 nanometers. A layer of the adhesive composition transmits no more than 10% of light in the wavelength range of 350-700 nanometers and transmits at least 75% of light in the wavelength range of 900-1200 nanometers.

### SUMMARY

Disclosed herein are adhesive compositions. In some embodiments, the adhesive composition comprises a pressure sensitive adhesive, and at least 2 light absorbing components dispersed within the pressure sensitive adhesive, where the light absorbing components comprise dyes, nanopigments or a combination thereof. The light absorbing components absorb light in the wavelength range of 350-700 nanometers. A layer of the adhesive composition transmits no more than 10% of light in the wavelength range of 350-700 nanometers and transmits at least 75% of light in the wavelength range of 900-1200 nanometers.

Also disclosed are articles. In some embodiments, the articles comprise an optical film substrate with a first major surface and a second major surface, and an adhesive layer disposed on at least a portion of the first major surface of the optical film substrate. The adhesive layer comprises the adhesive composition described above. The article transmits no more than 0.5% of light in the wavelength range of 350-700 nanometers and transmits at least 75% of light in the wavelength range of 900-1200 nanometers.

### BRIEF DESCRIPTION OF THE DRAWINGS

The present application may be more completely understood in consideration of the following detailed description of various embodiments of the disclosure in connection with the accompanying drawings.

FIG. 1 is optical transmission spectra of pressure sensitive adhesives of this disclosure.

FIG. 2 is optical transmission spectra of optical articles of this disclosure.

### DETAILED DESCRIPTION

A wide range of optical articles are being developed for a wide range of uses. Among the optical articles are optical filters. Optical filters are employed in a wide variety of applications such as optical communication systems, sensors, imaging, scientific and industrial optical equipment, and display systems. Optical filters may include optical layers that manage the transmission of incident electromagnetic radiation, including light. Optical filters may reflect of absorb a portion of incident light and transmit another portion of incident light. Optical layers within an optical filter may differ in wavelength selectivity, optical transmittance, optical clarity, optical haze, and index of refraction. The optical layers may be films, including multi-layer films and adhesive layers.

Wavelength selective filters are used in a variety of optical sensors such as fingerprint sensors, cameras, health sensors such as pulseox or PPG, automotive Lidar, remote control systems, NIR cameras, proximity sensors and the like. The operational range of optical sensors is commonly in the visible and near infrared to 1000 nm or further. Improving signal to noise by reducing noise light sources from ambient light such as fluorescent, LED, or even the sun is important to improve system performance. Typically, such devices use an optical filter of a dye in polycarbonate or in some cases an interference filter to selectively block unwanted wavelengths. This adds an extra component and thickness which is undesirable. Since many of these applications use optical adhesives, it is an advantage to incorporate the wavelength filter function without adding an extra component.

Optically clear adhesives (optical grade PSAs, hereinafter referred to as “OCA”) are widely used in a wide variety of articles and have increasingly stringent property requirements. Not only do these adhesives have to have desirable optical properties and maintain these properties in a variety of environmental conditions, but they also have to fulfill the role of an adhesive namely, to adhere together to substituents. In addition to these properties, the adhesives are also being formulated to carry out a variety of additional functions. As mentioned above, it is desirable that the adhesive function to cooperate with films that block unwanted wavelengths of light, or the adhesive can block wavelength ranges that are different from that of the film.

Therefore, a need remains for adhesives for use in optical laminates that provide the combination of adhesive properties, optical properties including selective wavelength filtering, and environmental stability. Among the environmental conditions to which it is desirable that the adhesive be resistant are heat, humidity or a combination of heat and humidity. In particular, it is desirable to have pressure sensitive adhesive layers that blocks light in the wavelength range of 350-700 nanometers and transmits light in the wavelength range of 900-1200 nanometers.

Disclosed herein are adhesive compositions comprising a pressure sensitive adhesive, and at least 2 light absorbing components dispersed within the pressure sensitive adhesive, where the light absorbing components comprise dyes, nanopigments or a combination thereof. Layers of the adhesive compositions transmits no more than 10% of light in the wavelength range of 350-700 nanometers and transmits at least 75% of light in the wavelength range of 900-1200 nanometers. Also disclosed are articles prepared with these adhesive compositions.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate functional” are materials that contain one or more (meth)acrylate groups.

The terms “room temperature” and “ambient temperature” are used interchangeably to mean temperatures in the range of 20° C. to 25° C.

The terms “Tg” and “glass transition temperature” are used interchangeably. If measured, Tg values are determined by Differential Scanning calorimetry (DSC) at a scan rate of 10° C./minute, unless otherwise indicated. Typically, Tg values for copolymers are not measured but are calculated using the well-known Fox Equation, using the monomer Tg values provided by the monomer supplier, as is understood by one of skill in the art.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 90% and a haze of less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 95%, often higher such as 97%, 98% or even 99% or higher.

Disclosed herein are adhesive compositions. In some embodiments, the adhesive composition comprises a pressure sensitive adhesive, and at least 2 light absorbing components dispersed within the pressure sensitive adhesive, where the light absorbing components comprise dyes, nanopigments or a combination thereof. The light absorbing components absorb light in the wavelength range of 350-700 nanometers. A layer of the adhesive composition transmits no more than 10% of light in the wavelength range of 350-700 nanometers and transmits at least 75% of light in the wavelength range of 900-1200 nanometers. In some embodiments, the adhesive composition transmits no more than 5% of light in the wavelength range of 350-700 nanometers and transmits at least 75% of light in the wavelength range of 900-1200 nanometers. In yet other embodiments, the adhesive composition transmits no more than 1% of light in the wavelength range of 350-700 nanometers and transmits at least 75% of light in the wavelength range of 900-1200 nanometers.

The adhesive composition comprises a pressure sensitive adhesive. The pressure sensitive adhesive comprises at least one polymeric component and may additionally comprise additional components such a tackifying resins, plasticizing resins, and the like as long as the additives do not interfere with the optical properties of the adhesive composition.

The pressure sensitive adhesive comprises a (meth)acrylate pressure sensitive adhesive, a (meth)acrylate-based pressure sensitive adhesive, a polyolefin pressure sensitive adhesive, a polyurethane pressure sensitive adhesive, or a combination thereof. Each of these classes of polymeric pressure sensitive adhesives are well understood in the adhesive arts. Polyolefin pressure sensitive adhesives, also called a poly(l-alkene) pressure sensitive adhesives, are polymers or co-polymers prepared from olefin monomers. The polymers may also include radiation activatable functional groups grafted thereon as described in U.S. Pat. No. 5,209,971 (Babu, et al). Polyurethane pressure sensitive adhesives useful in the disclosure include, for example, those disclosed in U.S. Pat. No. 3,718,712 (Tushaus); U.S. Pat. No. 3,437,622 (Dahl); and U.S. Pat. No. 5,591,820 (Kydonieus et al.).

In some embodiments, the pressure sensitive adhesive comprises a (meth)acrylate pressure sensitive adhesive or a (meth)acrylate-based pressure adhesive comprising: one or more alkyl (meth)acrylate monomers with 4-12 carbon atoms, and may contain one or more hydroxyl groups; and at least one reinforcing monomer. Such pressure sensitive adhesives generally have a glass transition temperature of about −20° C. or less. Examples of suitable alkyl (meth)acrylate monomers include for example, isooctyl acrylate, 2-ethyl-hexyl acrylate, n-butyl acrylate, HEA (hydroxyl ethyl acrylate), and HEMA (hydroxyl ethyl methacrylate). Examples or reinforcing monomers include, for example, (meth)acrylic acid, (meth)acrylamide, ethylene vinyl acetate, N-vinyl pyrrolidone and styrene macromers.

The adhesive composition also comprises at least 2 light absorbing components dispersed within the pressure sensitive adhesive, where the light absorbing components comprise dyes, nanopigments or a combination thereof. For example, in some embodiments, the adhesive composition comprises at least 2 nanopigments, in other embodiments, the adhesive composition comprises at least a nanopigment and a dye, and in yet other embodiments, the adhesive composition comprises at least 2 dyes. These components are described below.

The light absorbing components are selected to absorb light in the wavelength range of 350-700 nanometers, which encompasses the visible light range, and transmit light in the range of 900-1200 nanometers which encompasses the IR light range. To measure the transmission of light, the adhesive composition is formed into a layer. A layer of the adhesive composition transmits no more than 10% of light in the wavelength range of 350-700 nanometers and transmits at least 75% of light in the wavelength range of 900-1200 nanometers. In some embodiments, the adhesive composition transmits no more than 5% of light in the wavelength range of 350-700 nanometers and transmits at least 75% of light in the wavelength range of 900-1200 nanometers. In yet other embodiments, the adhesive composition transmits no more than 1% of light in the wavelength range of 350-700 nanometers and transmits at least 75% of light in the wavelength range of 900-1200 nanometers.

In some embodiments, the light absorbing components comprise nanopigments or nanopigments in combination with a one or more of the dyes described below. A nanopigment is a pigment that generally has an average particle size in the nanometer range. In embodiments, a nanopigment can have an average particle size from about 1 nm to about 1000 nm. Nanopigments can be useful because of the interaction of light with them; light will diffract from nanopigments because of their size, which can contribute to high reflectivities. In embodiments, a nanopigment can have an average particle size from about 50 nm to about 500 nm. An exemplary nanopigment that can be utilized includes CABOJET 300, which is commercially available from Cabot Corporation (Boston, MA).

In many embodiments, the adhesive composition comprises at least 2 dyes as the light absorbing components. A wide range of dyes are suitable. Examples of suitable dyes include a phthalocyanine dye, a dimonium dye, an anthraquinone dye, an aminium dye, a cyanine dye, a merocyanine dye, a croconium dye, a Squary lium dye, an azulenium dye, a polymethyne dye, a naph thoguinone dye, a pyrilium dye, a phthalocyanine dye, a naphthalocyanine dye, a naphlolactam dye, an azo dye, a condensed azo dye, an indigo dye, a perinone dye, a perylene dye, a dioxadine dye, a quinacridone dye, an isolindorynone dye, a quinophthalone dye, a pyrrol dye, a thioindigo dye, a metal complex dye, a dithiol metal complex dye, an indolphenol dye or a triallylmethane dye, and combinations thereof.

Examples of particularly suitable dyes include the commercially available visible light absorbing dyes from Epolm, Newark, NJ under the trade name “EPOLIGHT” such as EPOLIGHT 5393, and EPOLIGHT 5843, and the IR absorbing dye EPOLIGHT 6818. Also suitable is the dye with CAS Number 211991-63-8, Cyclobutenediylium, 1,3-bis(2,3-dihydro-2,2-bis(((1-oxohexyl)oxy)methyl)-1H-perimidin-4-yl)2,4-dihydroxy, bis (Inner salt) commercially available from Ferrania Technologies, Cairo Montenotte, Italy. This disclosure also describes the synthesis in the Examples section of a dye that is suitable, 3-butyl-1,1,2-trimethyl-1H-benzo[e]indol-3-ium iodide, called “55-1”.

The 2 dyes are different from each other. Typically, the at least 2 dyes have different lambda max values, and each lambda max is in the wavelength range of 350-700 nanometers. Lambda max is well understood in the optical arts and refers to the wavelength along the absorption spectrum where a substance has its strongest photon absorption.

Not only can the identity of the 2 dyes be varied, but also the amount of dye present in the adhesive composition can be varied. In some embodiments, the 2 dyes comprise 3-4% by weight of the total weight of the adhesive composition. In some embodiments, each light absorbing dye is present in an amount of no more than 2% by weight.

Also disclosed herein are articles. In some embodiments, the article comprises an optical film substrate with a first major surface and a second major surface, and an adhesive layer disposed on at least a portion of the first major surface of the optical film substrate. The adhesive layer comprises the adhesive compositions described above. The adhesive composition comprises a pressure sensitive adhesive, and at least 2 light absorbing components dispersed within the pressure sensitive adhesive, where the light absorbing components comprise dyes, nanopigments, or a combination thereof. The light absorbing components absorb light in the wavelength range of 350-700 nanometers, and a layer of the adhesive composition transmits no more than 10% of light in the wavelength range of 350-700 nanometers and transmits at least 75% of light in the wavelength range of 900-1200 nanometers, wherein the article transmits no more than 0.5% of light in the wavelength range of 350-700 nanometers and transmits at least 75% of light in the wavelength range of 900-1200 nanometers.

A wide range of optical film substrates are suitable. Typically, the optical film substrate is a visible light reflecting and IR transmitting film such that the layer of adhesive composition complements the visible light reflecting film to further enhance the blocking of visible light.

In some embodiments, the optical film substrate comprises a multi-layer film. Particularly suitable optical substrates are those that comprise a wavelength selective reflective layer comprising an interference filter comprising a plurality of polymeric layers. Examples of such films are described, for example, in U.S. Pat. No. 11,054,556.

The article also comprises an adhesive layer. The adhesive layers are prepared from the adhesive compositions described above. The adhesive composition comprises a pressure sensitive adhesive and at least 2 light absorbing components, where the light absorbing components are nanopigments, dyes, or a combination thereof. The components and properties of the adhesive compositions are described in detail above. The adhesive layer can have a wide range of thicknesses. In some embodiments, the adhesive layer has a thickness of from 15-200 micrometers.

As mentioned above, the adhesive layer complements the properties of the optical film substrate, namely the blocking of visible light and the transmission of IR light. In particular, in some embodiments, the article transmits no more than 0.2% of light in the wavelength range of 350-700 nanometers and transmits at least 75% of light in the wavelength range of 900-1200 nanometers. In other embodiments, the article transmits no more than 0.01% of light in the wavelength range of 350-700 nanometers and transmits at least 75% of light in the wavelength range of 900-1200 nanometers.

### EXAMPLES

These examples are merely for illustrative purposes only and are not meant to be limiting on the scope of the appended claims. All parts, percentages, ratios, etc. in the examples and the rest of the specification are by weight, unless noted otherwise. The following abbreviations are used: RPM=revolutions per minute; g=grams; L=liters; mL=milliliters; mmol=millimoles; min=minutes; ppm=parts per million; psi=pounds per square inch; kPa=kiloPascals; IV=Inherent Viscosity. The terms “weight %”, “% by weight”, and “% wt” are used interchangeably.

Table of Abbreviations

| Abbre- | |
|---|---|
| viation | |
| or Trade | |
| Desig- | |
| nation | Description |
| BA | Butyl acrylate (N-BUTYL ACRYLATE 10-20 PPM MEHQ, |
| | from BASF |
| 2-EHMA | 2-Ethylhexylmethacrylate (ETHYL METHACRYLATE |
| | 15 PPM MEHQ) from Lucite International Inc |
| 2-EHA | 2-Ethylhexyl acrylate from BASF |
| 2-HEA | Hydroxyethylacryalte (HYDROXY ETHYL ACRYLATE |
| | 97.0% MIN) from KOWA |
| ACM | Acrylamide from Mytech Specialty Chemicals |
| AA | Acrylic acid (GLACIAL ACRYLIC ACID 200 PPM |
| | MEHQ) from BASF |
| Thiol | pentaerythritol tetrakis(3-mercaptobutylate) crosslinking |
| | agent available as KARENZMT PE1 from Showa Denko |
| Initiator | Free radical initiator, 2,2 AZODI 2,4 |
| | DIMETHYLVALERONITRILE available as VAZO 52 |
| | from DuPont |
| EA | Ethyl Acetate solvent from Honeywell |
| BHT | (2,6-DI-TERT-BUTYL-4-METHYLPHENOL (B1378)) |
| | from Sigma Aldrich |
| IEM | 2-Isocyanatoethyl methacrylate from Showa Denko |
| Liner-1 | Silicone coated PET (polyethylene terephthalate) Liner |
| | available as RF32 from SKC Hass, Korea |
| Liner-2 | Silicone coated PET (polyethylene terephthalate) Liner |
| | available as RF02N from SKC Hass, Korea |
| BAX | Bisamide crosslinker (1,1′-isophthaloyl bis-1- |
| | methylaziridine), 5% wt in toluene, |
| DYE-1 | Visible absorbing dye EPOLIGHT 5393 from Epolin, |
| | Newark, NJ |
| DYE-2 | Visible absorbing dye EPOLIGHT 5843 from Epolin, |
| | Newark, NJ |
| DYE-3 | IR absorbing Phthalocyanine dye, EPOLIGHT 6818 |
| | from Epolin, Newark, NJ |
| DYE-4 | 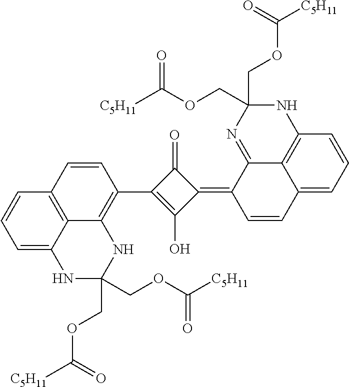 |
| | Cyclobutenediylium, 1,3-bis(2,3- |
| | dihydro-2,2-bis(((1-oxohexyl)oxy)methyl)-1H- |
| | perimidin-4-yl)2,4-dihydroxy, bis (Inner salt) from |
| | Ferrania Technologies, Cairo Montenotte, Italy |
| DYE-5 | 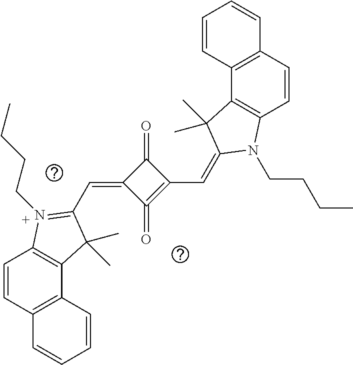 |
| | Dye 55-1, prepared as described |
| | below in Synthesis Example 1. |
| Optical | Near IR transmitting visible reflector film which |
| Film | was manufactured by 3M Company as |
| | described in PCT Publication No. 2020/053832. |

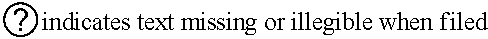

### Test Methods

### Optical Transmission Spectra

The Near IR and visible transmission spectra were collected using a LAMBDA UV/Vis/NIR spectrophotometer, model 950, from PerkinElmer.

### Synthesis Example S-1: Synthesis of Dye-5 (55-1 Dye)

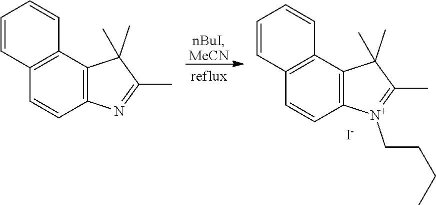

3-butyl-1,1,2-trimethyl-1H-benzo[e]indol-3-ium iodide: A 250 mL round bottom was charged with 1,1,2-trimethylbenzo[e]indole (10.0 g, 47.8 mmol), MeCN (50 mL, 954 mmol), and 1-iodobutane (11.0 g, 6.8 mL, 59.8 mmol) and heated to reflux overnight. The solvent was stripped and the resultant syrup was dissolved in 50 mL acetone and 200 mL diethyl ether was added; the syrup was then scratched against the flask with a metal spatula until a purple solid precipitated, the solid was filtered off and collected (5.5 g) and the filtrate was allowed to sit over night to give a second crop of precipitate that was again collected (7.6 g) the two crops of dark purple solids were combined to give 3-butyl-1,1,2-trimethyl-1H-benzo[e]indol-3-ium iodide (13.1 g, 33.3 mmol, 69.7% Yield). The structure was confirmed by ¹H NMR in (CD₃)₂CO.

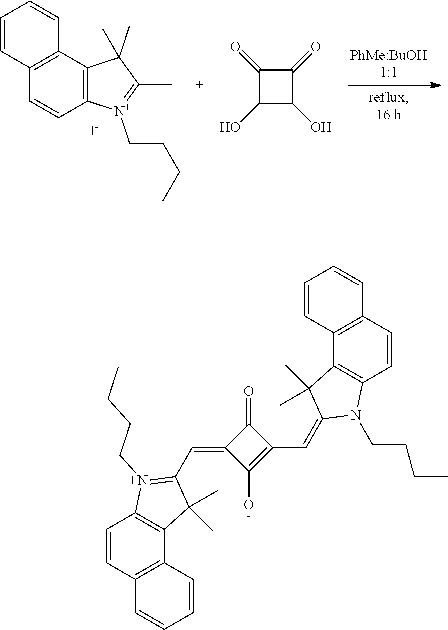 [SMILES: CCCC[N+]1=C(C)C(C)(C)c2c1ccc1ccccc21 ; [I-] ; O=C1C(=O)C(O)C1O ; CCCCN1/C(=C/C2=C(O)C(=C\C3=[N+](CCCC)c4ccc5ccccc5c4C3(C)C)/C2=O)C(C)(C)c2c1ccc1ccccc21]

(4E)-4-[(3-butyl-1,1-dimethyl-benzo[e]indol-3-ium-2-yl)methylene]-2-[(Z)-(3-butyl-1,1-dimethyl-benzo[e]indol-2-ylidene)methyl]-3-oxo-cyclobuten-1-olate: A 100 mL round bottom flask equipped with a Dean Stark trap was charged with 2-butyl-1,1,3-trimethyl-benzo[e]isoindol-2-ium iodide (1.70 g, 4.32 mmol), 3,4-dihydroxycyclobut-3-ene-1,2-dione (0.250 g, 2.19 mmol), 10 mL toluene, and 10 mL 1-butanol and heated to 115° C. overnight, the reaction turned a dark green color. The reaction was cooled, and the solvent removed. The resultant dark green and rust colored sludge was dissolved in 50 mL acetone and then 100 mL Et₂O was added; the side of the flask was scratched with a metal spatula and a red rust colored solid precipitated and was isolated by filtration. The filtrate was concentrated down to a sludge again and this time dissolved in 5 mL acetone and 10 mL Et₂O was added this was filtered the solids were combined to give a dark green brown solid (1.03 g, 1.69 mmol, 77.2% Yield). The structure was confirmed by ¹H NMR in (CD₃)₂CO.

### Examples 1-3

### Synthesis of Pressure Sensitive Adhesive Polymer Solution

504 g 2-EHA, 640 g BA, 160 g 2-EHMA, 48 g ACM, 240 g HEA, 8 g AA, 3.52 g Thiol and 1600 g EA were charged into a 5L Buchi reactor. The solution was heated up to and mixed for 30 minutes use 150 rpm agitation. 0.32 g Initiator was dissolved in 10 g EA, then added into the reactor. The reactor was purged with N₂ (pressure-release) for several times until the reaction started. The start of the reaction was indicated by the batch temperature increase and jacket temperature decrease. Once the reaction was started, kept the reaction under 5 psi (34 kPa) N₂ pressure with 150 rpm agitation speed. The reaction was held at 60° C. for 5 hours. 1.12 g Initiator was dissolved in 25 g of EA in a jar. It was then transferred into a 50 mL charge bomb. O₂ was removed from charge bomb by purging with N₂ 5 times. After 5 hours of reaction, the pre-dissolved Initiator was charged into reactor. The reaction temperature was then increased to 65° C. and kept at 65° C. for 12 hours. The final polymer solution is adjusted with ethyl acetate to 45% wt solid with IV=0.79.

### Preparation of Dye Stock Solutions

Stock solutions of Dyes 1-5 were prepared at 10% wt by dissolving the dyes in methyl ethyl ketone (MEK).

### Preparation of Adhesive Compositions

Example 1: In a 4-ounce brown jar were placed 40 g of 45% wt of the pressure sensitive adhesive polymer prepared above and 20 g of MEK, then 1.8 g of Dye-5 10% wt stock solution, 1.0 g of Dye-2 10% wt stock solution, 1.8 g of Dye-1 10% wt stock solution were added. The bottle was then placed on a roller overnight. Before making adhesive samples, 1.08 g of BAX (5% wt in toluene) was added. The final solution was placed on a roller for an additional 1 hour before coating.

Example 2: In a 4-ounce brown jar were placed 40 g of 45% wt of the pressure sensitive adhesive polymer prepared above and 20 g of MEK, then 1.8 g of Dye-5 10% wt stock solution, 1.0 g of Dye-2 10% wt stock solution, 1.8 g of Dye-1 10% wt stock solution, and 1.8 g of Dye-3 10% wt stock solution were added. The bottle was then placed on a roller overnight. Before making adhesive samples, 1.08 g of BAX (5% wt in toluene) was added. The final solution was placed on a roller for an additional 1 hour before coating.

Example 3: In a 4-ounce brown jar were placed 40 g of 45% wt of the pressure sensitive adhesive polymer prepared above and 20 g of MEK, then 1.8 g of Dye-5 10% wt stock solution, 1.0 g of Dye-2 10% wt stock solution, 1.8 g of Dye-1 10% wt stock solution, 1.8 g of Dye-4 10% wt stock solution. and 1.8 g of Dye-3 10% wt stock solution were added. The bottle was then placed on a roller overnight. Before making adhesive samples, 1.08 g of BAX (5% wt in toluene) was added. The final solution was placed on a roller for an additional 1 hour before coating.

### Preparation of Pressure Sensitive Adhesive Layers

Layers of the adhesive compositions prepared above were coated to form layers. The layers were prepared by coating the adhesion composition solutions described above on layers of Liner-1 using a knife coater, the gap between the liner and knife was set at 100 micrometers. The coating solutions were applied on Liner-2, and hand-pulled through gap between knife coater and the liner. The wet-adhesive solutions were placed on a board and then in 70° C. oven for 30 min. After the solvents were dried, the top liner of Liner-2 was applied using a hand-roller. The adhesive thickness was measured as approximately 25 micrometers.

### Optical Measurements

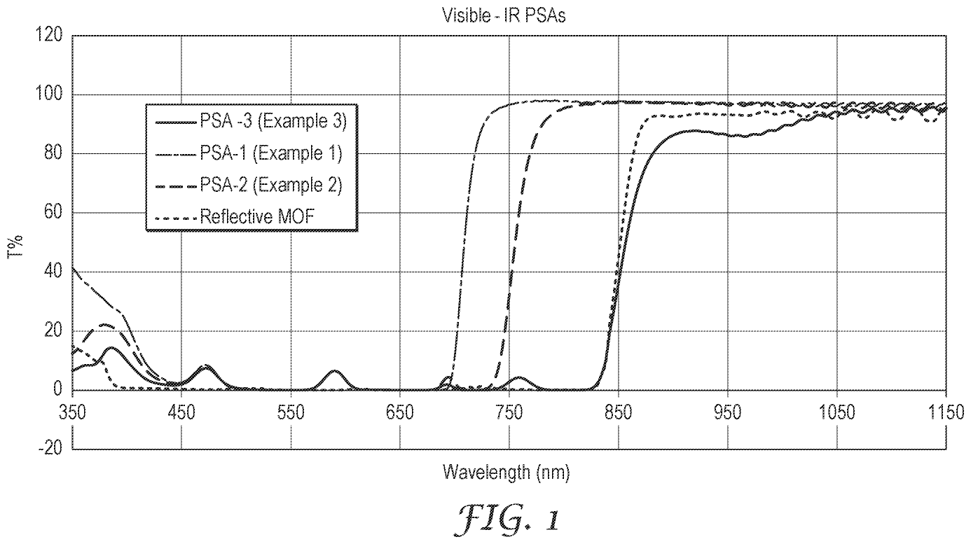

The layers of adhesive compositions for Examples 1-3 had Optical Transmission Spectra taken as described in the Test Method above. The Spectra, along with the Spectra of Optical Film, are shown below in FIG. 1. The samples are labeled PSA-1 (Example 1), PSA-2 (Example 2), PSA-3 (Example 3), and reflective MOF for the Optical Film.

### Preparation and Testing of Optical Articles

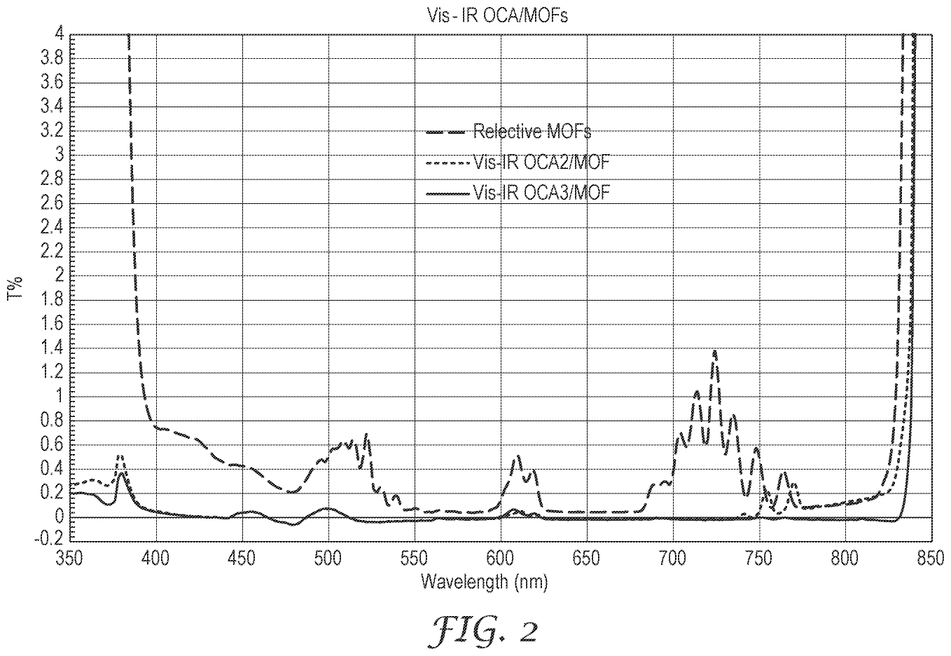

Optical Articles were prepared by laminating the Adhesive Layers of Example-2 (called PSA-2) and Example-3 (called PSA-3) to Optical Film. Optical Transmission Spectra were taken of the Optical film and the laminates of Optical Film/PSA-2 and Optical Film/PSA-3. The spectra are shown in FIG. 2. The samples are labeled reflective MOF for the Optical Film, OCA2/MOF for the laminate of Optical Film and Example 2, OCA3/MOF for the laminate of Optical Film and Example 3. As can be seen in FIG. 2, the PSAs are complements to the Optical Film and improve the reduction of visible light transmission over the Optical Film itself

What is claimed is:

1. An adhesive composition comprising:
a pressure sensitive adhesive; and
at least 2 light absorbing components dispersed within the pressure sensitive adhesive, wherein the light absorbing components comprise dyes, nanopigments or a combination thereof, and wherein the light absorbing components absorb light in the wavelength range of 350-700 nanometers, and wherein a layer of the adhesive composition transmits no more than 10% of light in the wavelength range of 350-700 nanometers and transmits at least 75% of light in the wavelength range of 900-1200 nanometers.

2. The adhesive composition of claim 1, wherein the pressure sensitive adhesive comprises a (meth)acrylate pressure sensitive adhesive, a (meth)acrylate-based pressure sensitive adhesive, a polyolefin pressure sensitive adhesive, a polyurethane pressure sensitive adhesive, or a combination thereof.

3. The adhesive composition of claim 1, wherein the pressure sensitive adhesive comprises a (meth)acrylate pressure sensitive adhesive or a (meth)acrylate-based pressure adhesive comprising:
one or more alkyl (meth)acrylate monomers with 4-12 carbon atoms, and may contain
one or more hydroxyl groups; and
at least one reinforcing monomer.

4. The adhesive composition of claim 1, wherein the at least 2 light absorbing components comprise 2 nanopigments, a nanopigment and a dye, or 2 dyes.

5. The adhesive composition of claim 1, wherein the at least 2 light absorbing components comprise dyes that comprise 3-4% by weight of the total weight of the adhesive composition.

6. The adhesive composition of claim 5, wherein each light absorbing dye is present in an amount of no more than 2% by weight.

7. The adhesive composition of claim 1, wherein the at least 2 light absorbing components comprise dyes wherein the 2 dyes have different lambda max values, and each lambda max is in the wavelength range of 350-700 nanometers.

8. The adhesive composition of claim 1, wherein the at least 2 light absorbing components comprise dyes wherein the dyes are selected from a phthalocyanine dye, a dimonium dye, an anthraquinone dye, an aminium dye, a cyanine dye, a merocyanine dye, a croconium dye, a Squary lium dye, an azulenium dye, a polymethyne dye, a naph thoguinone dye, a pyrilium dye, a phthalocyanine dye, a naphthalocyanine dye, a naphlolactam dye, an azo dye, a condensed azo dye, an indigo dye, a perinone dye, a perylene dye, a dioxadine dye, a quinacridone dye, an isolindorynone dye, a quinophthalone dye, a pyrrol dye, a thioindigo dye, a metal complex dye, a dithiol metal complex dye, an indolphenol dye or a triallylmethane dye, and combinations thereof.

9. The adhesive composition of claim 1, wherein the adhesive composition transmits no more than 5% of light in the wavelength range of 350-700 nanometers and transmits at least 75% of light in the wavelength range of 900-1200 nanometers.

10. The adhesive composition of claim 1, wherein the adhesive composition transmits no more than 1% of light in the wavelength range of 350-700 nanometers and transmits at least 75% of light in the wavelength range of 900-1200 nanometers.

11. An article comprising:
an optical film substrate with a first major surface and a second major surface, and an adhesive layer disposed on at least a portion of the first major surface of the optical film substrate, wherein the adhesive layer comprises an adhesive composition comprising:
a pressure sensitive adhesive; and
at least 2 light absorbing components dispersed within the pressure sensitive adhesive,
wherein the light absorbing components comprise dyes, nanopigments, or a
combination thereof, and wherein the light absorbing components absorb light in the
wavelength range of 350-700 nanometers, and wherein a layer of the adhesive
composition transmits no more than 10% of light in the wavelength range of 350-700
nanometers and transmits at least 75% of light in the wavelength range of 900-1200
nanometers,
wherein the article transmits no more than 0.5% of light in the wavelength range of 350-700 nanometers and transmits at least 75% of light in the wavelength range of 900-1200 nanometers.

12. The article of claim 11, wherein the optical film substrate comprises a multi-layer film.

13. The article of claim 11, wherein the optical film substrate comprises a wavelength selective reflective layer comprising an interference filter comprising a plurality of polymeric layers.

14. The article of claim 11, wherein the adhesive layer has a thickness of from 15-200 micrometers.

15. The article of claim 11, wherein the article transmits no more than 0.2% of light in the wavelength range of 350-700 nanometers and transmits at least 75% of light in the wavelength range of 900-1200 nanometers.

16. The article of claim 11, wherein the article transmits no more than 0.01% of light in the wavelength range of 350-700 nanometers and transmits at least 75% of light in the wavelength range of 900-1200 nanometers.

17. The article of claim 11, wherein the pressure sensitive adhesive comprises a (meth)acrylate pressure sensitive adhesive, a (meth)acrylate-based pressure sensitive adhesive, a polyolefin pressure sensitive adhesive, a polyurethane pressure sensitive adhesive, or a combination thereof.

18. The article of claim 11, wherein the at least 2 light absorbing components comprise dyes that comprise 3-4% by weight of the total weight of the adhesive composition.

19. The article of claim 18, wherein each light absorbing dye is present in an amount of no more than 2% by weight.

20. The article of claim 11, wherein the at least 2 light absorbing components comprise dyes, wherein the dyes are selected from a phthalocyanine dye, a dimonium dye, an anthraquinone dye, an aminium dye, a cyanine dye, a merocyanine dye, a croconium dye, a Squary lium dye, an azulenium dye, a polymethyne dye, a naph thoguinone dye, a pyrilium dye, a phthalocyanine dye, a naphthalocyanine dye, a naphlolactam dye, an azo dye, a condensed azo dye, an indigo dye, a perinone dye, a perylene dye, a dioxadine dye, a quinacridone dye, an isolindorynone dye, a quinophthalone dye, a pyrrol dye, a thioindigo dye, a metal complex dye, a dithiol metal complex dye, an indolphenol dye or a triallylmethane dye, and combinations thereof.
